(19) United States
(12) Patent Application Publication
(10) Pub. No.: US 2026/0041974 A1
(43) Pub. Date: Feb. 12, 2026

(54) SYSTEM AND METHOD FOR GOLF COURSE TURN BY TURN INSTRUCTIONS

(71) Applicant: Textron Inc., Providence, RI (US)

(72) Inventors: Brian David Wanta, North Augusta, SC (US); Preston Sering Easley, Martinez, GA (US)

(21) Appl. No.: 18/795,901

(22) Filed: Aug. 6, 2024

(51) Int. Cl. A63B 55/60; A63B 71/06; G01C 21/30

(52) U.S. Cl. CPC A63B 55/61; A63B 71/06; G01C 21/30; A63B 2071/0691; A63B 2220/12

(57) ABSTRACT

A navigation system for a golf course includes one or more processing circuits. The one or more processors circuits are configured to acquire group data associated with a plurality of vehicles including a plurality of player identifiers and a plurality of cart identifiers; associate each one of the plurality of player identifiers with a respective one of the plurality of cart identifiers; acquire navigation data associated the golf course including a plurality of starting tee locations; associate each one of the plurality of vehicles with a respective one of the plurality of starting tee locations; determine, based on the group data and the navigation data, a shortest route, for each particular vehicle of the plurality of vehicles, to the respective one of the starting tee locations assigned to the particular vehicle; and simultaneously provide, via the operator interface of each particular vehicle, the shortest route to the starting tee location.

### BACKGROUND

Golf courses typically host tournaments and/or events for members and non-members. Such events often involve large groups of players/golfers all starting at the same time on every hole. This format is known as a shotgun start. Shotgun starts can be difficult to coordinate for the golf course staff and usually require extensive time and energy to guide each group to their starting hole. Further, current navigation systems and devices lack the ability to coordinate and provide instructions to players after a shotgun start.

### SUMMARY

One embodiment relates to a navigation system for a golf course. The navigation system includes a plurality of vehicles, each having an operator interface, and one or more processing circuits including one or more memory devices. The memory devices have instructions thereon that, when executed by one or more processors, cause the one or more processors to acquire group data associated with the plurality of vehicles, the group data comprising a plurality of player identifiers and a plurality of cart identifiers; associate each one of the plurality of player identifiers with a respective one of the plurality of cart identifiers; acquire navigation data associated with at least one of the golf course or the plurality of vehicles, the navigation data comprising a plurality of starting tee locations of the golf course; associate each one of the plurality of vehicles with a respective one of the plurality of starting tee locations; determine, based on the group data and the navigation data, a shortest route, for each particular vehicle of the plurality of vehicles, to the respective one of the starting tee locations assigned to the particular vehicle of the plurality of vehicles; and simultaneously provide, via the operator interface of each particular vehicle, the shortest route to the starting tee location assigned to each particular vehicle of the plurality of vehicles.

Another embodiment relates to a navigation system for a golf course. The navigation system includes a non-transitory computer-readable medium having instructions stored thereon that, when executed by one or more processors, cause the one or more processors to acquire group data associated with the plurality of vehicles, the group data comprising a plurality of player identifiers and a plurality of cart identifiers; associate each one of the plurality of player identifiers with a respective one of the plurality of cart identifiers; acquire navigation data associated with at least one of the golf course or the plurality of vehicles, the navigation data comprising a plurality of starting tec locations of the golf course; associate each one of the plurality of vehicles with a respective one of the plurality of starting tee locations; determine, based on the group data and the navigation data, a shortest route, for each particular vehicle of the plurality of vehicles, to the respective one of the starting tee locations assigned to the particular vehicle of the plurality of vehicles; and simultaneously provide, via the operator interface of each particular vehicle, the shortest route to the starting tee location assigned to each particular vehicle of the plurality of vehicles.

Still another embodiment relates to a method for providing navigation instructions to a plurality of vehicles at a golf course. The method may include the steps of receiving group data associated with the plurality of vehicles, the group data comprising a plurality of player identifiers and a plurality of cart identifiers; associating each one of the plurality of player identifiers with a respective one of the plurality of cart identifiers; receiving navigation data associated with at least one of the golf course or the plurality of vehicles, the navigation data comprising a plurality of starting tee locations of the golf course; associating each one of the plurality of vehicles with a respective one of the plurality of starting tee locations; determining, based on the group data and the navigation data, a shortest route, for each particular vehicle of the plurality of vehicles, to the respective one of the starting tee locations assigned to the particular vehicle of the plurality of vehicles; and providing, via an operator interface of each particular vehicle, the shortest route to the starting tee location assigned to the particular vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a block diagram of a navigation system, according to an exemplary embodiment.

FIG. 5 is a diagram of an example golf course illustrating groups/pairs of players/carts, pathways, starting tee/pin locations, and other elements/information that may be utilized by the navigation systems, devices, and methods disclosed herein, according to an exemplary embodiment.

FIG. 6 is a diagram of the example golf course of FIG. 5, illustrating the navigation system determining and/or otherwise designating a shortest route for a particular vehicle from the vehicle's current location to a starting tee location associated with the particular vehicle.

FIG. 7 is an example GUI for providing navigation instructions to a particular vehicle, such as the vehicle of FIG. 6, according to an exemplary embodiment.

FIG. 8 is a diagram of the example golf course of FIG. 5, illustrating the navigation system determining and/or otherwise designating a shortest route for a particular vehicle from the vehicle's current location to a shelter location, according to an exemplary embodiment.

FIG. 9 is an example GUI for providing navigation instructions to a particular vehicle, such as the vehicle of FIG. 8, according to an exemplary embodiment.

FIG. 10 is a flow chart illustrating exemplary method steps of a method for providing navigation instructions to one or more vehicles at a golf course, according to an exemplary embodiment.

FIG. 11 is a flow chart illustrating additional exemplary method steps of the method of FIG. 10, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, navigation systems, methods, and devices may include one or more controllers configured to use group information, designated group starting holes, and course layout information to provide each specific cart directions to a respective starting hole. For example, directions may be simultaneously generated for each cart at an event having a large number of players/golfers designated to specific carts. The directions (e.g., instructions to navigate to a respective starting hole) may be displayed via a golf GPS screen installed on the particular vehicle. The screen may show the shortest route to the hole on which the respective group starts. Further, systems, methods, and devices disclosed herein may direct each vehicle back to a designated return location (e.g., a clubhouse) when their round is finished. Beneficially, this disclose eliminates the need for players to find their own way back (e.g., should they not complete each of the holes by an event end time, should they not finish their round on the final hole of the course, etc.), streamlines event management, extends the playtime for each player at the event, and minimizes the burden on golf course staff.

Further, the systems, methods, and the like disclosed herein may detect inclement weather or other indications signaling a need for golfers to take shelter. In this way and as discussed herein, shelter locations can be identified in real time and a shortest (e.g., a fastest) route to a shelter location may be provided that is customized/generated for each respective golfer based on their current position and/or the type of shelter condition. Beneficially, the systems and the like of this disclosure may provide directions to the nearest shelter or the fastest route back to the clubhouse based on their current position of each player/vehicle. Accordingly, the systems and the like disclosed herein improve the likelihood of avoiding inclement weather and hazards and prevent players from taking inefficient/slower routes when attempting to avoid weather, hazards, or the like.

### Overall Vehicle

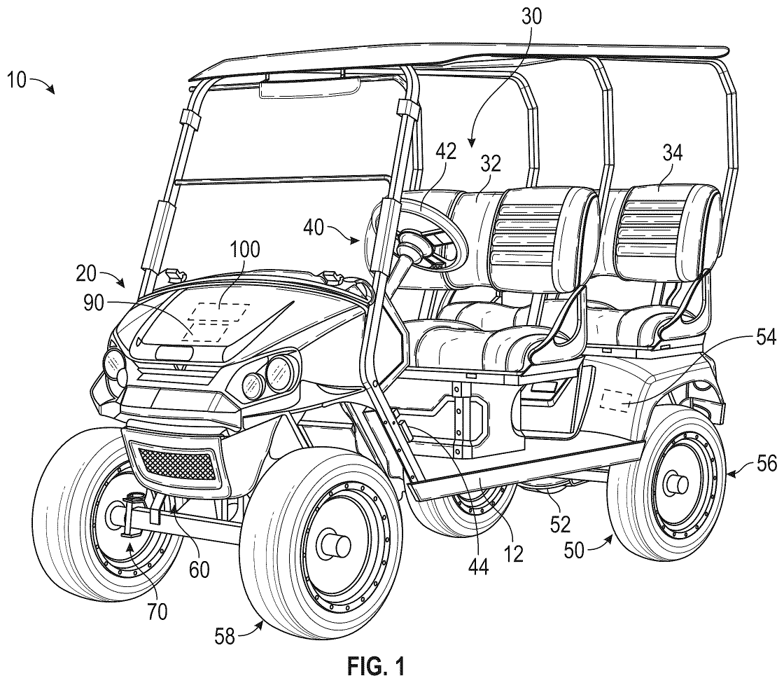

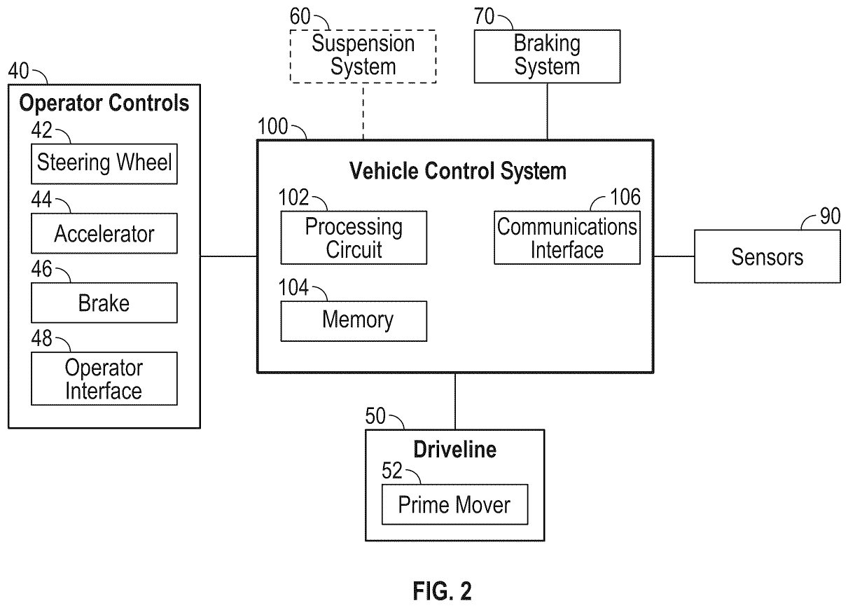

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, an LCD display, an LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

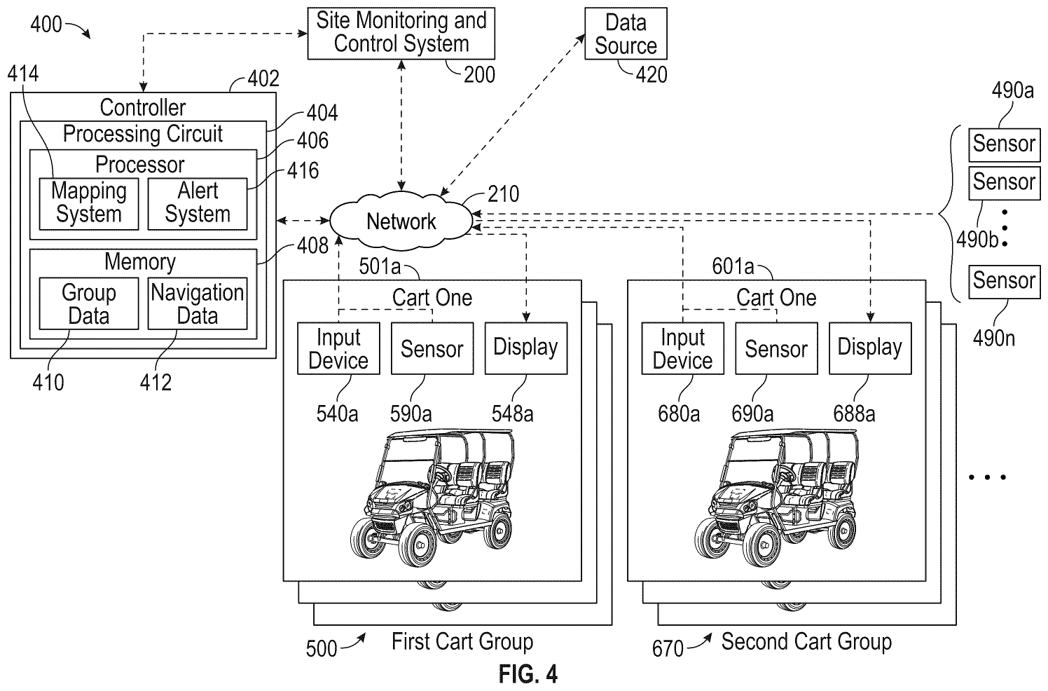

The sensors 90 (and 590, 690 as shown in FIG. 4) may include various sensors positioned about the vehicle 10 to acquire vehicle information or vehicle data regarding operation of the vehicle 10 and/or the location thereof. By way of example, the sensors 90, 590, 690 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90, 590, 690 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data. The one or more sensors 90, 590, 690 may detect qualities and/or features of the vehicle 10 that are relevant to determining the behavior of the vehicle 10 while in motion but may be otherwise independent of the movement of the vehicle 10. For example, vehicle qualities and/or features may include the mass, weight, size, wheelbase, drive type, location of the center of gravity, weight/mass distribution, current occupancy, state of charge, access status (e.g., unrestricted access, disabled, metered access), axes of direction relative to the vehicle 10, etc. of the vehicle 10.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

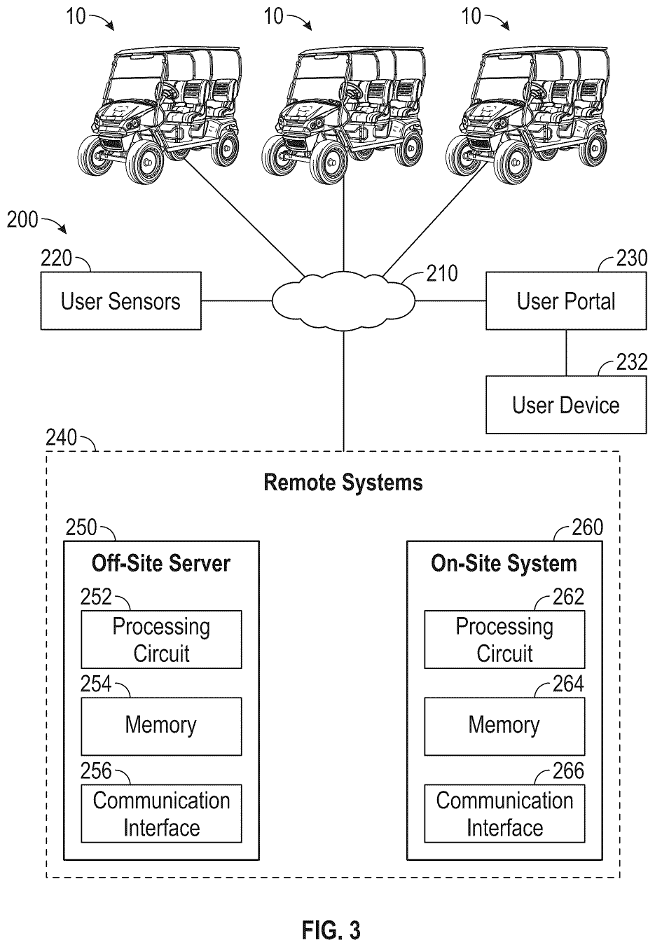

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10 and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 3, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Turn-by-Turn Golf Course Navigation System and Method

Referring to FIGS. 4-11, one or more of the vehicles 10 may be communicatively coupled to a navigation system 400 for a golf course. In some embodiments, the navigation system 400 may send and receive data from one or more data sources (e.g., a vehicle 10 and vehicle control system 100 having a processor and a memory, a vehicle control system 100 and one or more processing circuits associated with a vehicle 10, one or more controllers and/or processing circuits located on and/or remote to the vehicle 10, a site monitoring and control system 200, a data source 420, etc.) in order to determine and provide one or more sets of turn-by-turn directions for guiding one or more particular vehicles 10 along a shortest route from a first location (e.g., a starting location) to a second location (e.g., a target destination associated with the particular vehicle 10). In this way, the navigation system 400 may automatically associate one or more player identifiers with a designated cart (e.g., an assigned cart for that player out of a group of carts). The navigation system 400 may receive a designated start location, starting tee location, return location, shelter location, and/or the like assigned or otherwise associated with the player identifier and designated cart. Beneficially, the navigation system 400 determines a shortest route from the starting location (e.g., a current location of the vehicle 10, a designated start location such as a clubhouse or gathering location, etc.) to the target destination such as a starting tee assigned to the player/cart pair. In some embodiments, the navigation system 400 may receive data from a site monitoring and control system 200, data source 420, such as a tee sheet system or database, when determining/providing turn-by-turn directions simultaneously or substantially simultaneously for a plurality of carts (e.g., players/carts divided into groups for a “shotgun” start at a golfing event).

Accordingly, the navigation system 400 alleviates the site monitoring and control system 200, the course management/staff, and the players from expending computing power, energy, and time navigating to a starting hole, a shelter location, a return location, or the like. Further, as explained herein, the navigation system 400 may receive the current location associated with a particular cart and update (e.g., redetermine in real time) the shortest route to the target destination taking into consideration weather conditions, cart/pathway congestion, reported barriers/obstacles on a pathway, etc.). As shown in FIG. 4 and discussed herein, the navigation system 400 may monitor a movement/location of the vehicle 10, receive vehicle parameters, group data and/or navigation information, receive the starting location, current location, and/or target destination associated with one or more vehicles 10, determine a route and generate instructions for a GUI displaying the shortest route for a particular vehicle 10, and/or determine whether to alert/navigate each particular vehicle 10 of the plurality of vehicles 10 to return to or shelter at location based on one or more conditions (e.g., reaching a designated end time, reaching a designated final hole, receiving a signal indicative of inclement weather, etc.).

As used herein, turn-by-turn directions, a set of turn-by-turn directions, turn-by-turn instructions, and/or the like may refer to navigational instructions provided to an operator of a vehicle 10 to guide the operator from a first location (e.g., a starting location, a current location of the vehicle 10, etc.) to a second location (e.g., a designated starting tee, a designated starting area, a subsequent/next tec, a return location, a gathering location, a shelter location, etc.). The turn-by-turn directions may specify each turn or maneuver the operator of the vehicle 10 will make and/or that the vehicle 10 should take to travel from the first location to the second location. For example, the turn-by-turn directions may include a distance until a next turn, a direction/angle/bearing of a turn/maneuver, the name or description of the road or path to travel upon/avoid/turn onto/etc., and other any relevant landmarks, graphics, audio/visual prompts, or contextual information to guide the vehicle 10 from the first location to the second location. The turn-by-turn directions may be in the form of and/or displayed to the operator as sequential steps that update based on a current location of the vehicle 10. For example, prompts, steps, or other features of the turn-by-turn directions may include textual or audio instructions such as “Head north on path 12 for 500 meters, then turn right onto path 11.” Other directions may include “Your starting hole is hole 4, and your starting tee box is 200 feet ahead on the right.” Additional directions may include landmark and/or congestion information for improved navigation, such as: “Procced north on Fairway 18 for 100 yards, passing the bridge on your left,” “To avoid a congested route, continue straight for 100 feet then turn right onto path 7 of hole 3,” “Your destination, the clubhouse, is on the right side of Champions Drive after 100 meters,” and so on.

The turn-by-turn directions may also include visual map directions, such as prompts presented on a GPS screen, a highlighted route with arrows/markers indicating turns and distances, a virtual representation/model of the vehicle 10 on a map or in a virtual environment, and/or a camera view including graphic overlays illustrating/highlighting the path to take and/or a target direction of travel. In this way, the turn-by-turn directions could include any or all of: “Follow the highlighted route for 500 meters. Turn right where the route marker indicates the start of hole 11. Continue along the route and turn left towards the tee box of hole 11. The final destination is marked with a flag icon.” In some embodiments, interactive displays might be used, showing a moving dot/icon representing the cart on a screen, map, etc. These examples illustrate some varying formats and scopes that turn-by-turn directions can take, ranging from simple text instructions to interactive digital displays. Additional formats of directions (e.g., haptic/visual feedback causing a portion of the steering wheel 42 to light up/vibrate in a direction of travel, etc.) and combinations, sub-combinations, variations of any or all of the above are additionally contemplated and may fall within the scope of turn-by-turn directions as appropriate and as would be understood by a person of ordinary skill in the art.

Referring particularly to FIG. 4, an example block diagram of the navigation system 400 is shown, according to an exemplary embodiment. The navigation system 400 may include a controller 402 having one or more processing circuits 404 including one or more memory 408 devices and one or more processors 406. The memory 408 devices may store group data 410, navigation data 412, and/or other instructions that, when executed by one or more processors 406, cause the one or more processors 406 to perform the features of the navigation system 400 discussed herein. Similarly, the one or more processors 406 may include a mapping system 414 and/or an alert system 416 to facilitate performance of the features and/or methods discussed herein.

The navigation system 400 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. The processing circuit 404 may include an ASIC, one or more FPGAs, a DSP, circuits containing one or more processing components, circuitry for supporting a microprocessor, a group of processing components, or other suitable electronic processing components. In some embodiments, the processing circuit 404 is configured to execute computer code stored in the memory 408 to facilitate the activities described herein. The memory 408 may be any volatile or non-volatile or non-transitory computer-readable storage medium capable of storing data or computer code relating to the activities described herein. According to an exemplary embodiment, the memory 408 includes computer code modules (e.g., executable code, object code, source code, script code, machine code, etc.) configured for execution by the processing circuit 404. In some embodiments, the navigation system 400 may represent a collection of processing devices. In such cases, the processing circuit 404 represents the collective processors of the devices, and the memory 408 represents the collective storage devices of the devices.

The navigation system 400 may also include, comprise, and/or otherwise be communicatively coupled to one or more pluralities of vehicles 10 (e.g., one plurality of vehicles organized into groups and/or each operated independently, a first plurality of a first type of golf cart and a second plurality of a second type of golf cart operating/intermixed/etc. into groups and/or independently, or the like). For example, as shown in FIG. 4, the navigation system 400 may include a first group of vehicles 500 (e.g., a first cart group having 1-4 carts, such as a pod of four carts, each designated the same starting hole for a shotgun start golfing event). The navigation system 400 may also include, comprise, and/or otherwise be communicatively coupled to a second plurality of carts 670 (e.g., a second cart group 670 such as a pod of carts, each designated the same starting hole for a shotgun start golfing event), a third plurality of carts, additional vehicle(s) 10, etc. As described herein, the navigation system 400 may be configured to generate turn-by-turn directions for each group of carts 500, 670 and/or each particular vehicle 10 of the one or more pluralities of vehicles 10.

Each respective cart may include a respective input device (e.g., input device 540a for cart one 501a of the first cart group 500), sensor(s) (e.g., sensors 590a for cart one 501a), and/or an operator interface such as a display (e.g., display 548a for cart one 501a). In this way, each vehicle 10 of the plurality of vehicles may send/receive data to the navigation system 400 relevant to the generation, updating, etc. of the shortest route from a first location to a second location associated with the particular vehicle 10.

In some embodiments, the group data 410 includes one or more player identifiers, a group/grouping of players, a number of players in the group of players, event information associated with an event at the golf course, etc. For example, player identifiers may include a player name, a registration/member/account number associated with one or more players, a phone number, email, or the like associated with one or more players, or any other data sufficient to identify or otherwise distinguish the player from among a group of players and/or to identify the player at the golf course. The group/grouping of players may include a set of player identifiers or any other data designating the players into a group. For example, the group may include a pod of players each golfing/starting on the same hole of the golf course during an event, a group of players sharing the same particular golf cart, players designated as a team of players, all or a portion of the players registered for a certain event, or the like. The group of players may include or have a number of players comprising the group, such as a 4-player pod in a golf event and/or tournament, a single player designated a starting hole on his/her own, a number of players assigned to the same cart, a number of players golfing on the same hole, etc.

Event information may include a name of the event, a number of rounds/holes associated with the event, an event start time and/or end time (e.g., play begins at 9:00 am, players return at 5:30 pm, event ends at sundown, etc.). Event information may also include a ranking of players, a score/difficulty associated with the event and/or the golf course, a rule or set of rules associated with the event, or the like.

As described herein, any or all of the group data 410 may be generated by the controller 402, received from the site monitoring system 200, received from the data source 420, received via the network 210, received (e.g., via a manual input, via an operator interface, etc.) from a computer, the vehicle 10, or the like, and/or received from a sensor 490. For example, in some embodiments, any and/or all of the group data 410 may be received, pulled from, and/or stored via a tee sheet system operated by the golf course, a pro shop, and/or associated with a golf event.

The navigation data 412 may comprise at least one of a course layout, a tee location, a pin location, a current location of a particular vehicle 10 for one or more of the plurality of vehicles 10, a shelter location, a clubhouse location, a cart storage location, an event gathering location, or the like. For example, the course layout may include a map of various routes, pathways, and/or holes of the golf course. The course layout may include one or more areas designated via geofences or markers such as a hazard (e.g., water hazard, sand trap, construction zone, maintenance area, etc.), a no-cart zone (e.g., waterlogged fairway, private property lines, etc.), a green location, or the like. The course layout may also include the location of one or more buildings or structures such as a clubhouse, a cart storage building, a rest stop, a pro shop, or the like. The pin location and/or the tee location may include a designated marker/area of the course layout, a geofence designating a pin and/or tee box, geographic coordinates associated with a pin and/or tee box, or the like. Similarly, the clubhouse location and/or cart storage location may be referenced/identified via a geofence, included in the course layout information, specified based on a distance and/or geographic coordinates, GPS information, etc.

The event gathering location may be specified or may be varied based on a particular event at the golf course. For example, a half-day tournament open to non-members of the golf-course may be associated with a gathering location as the start of the front nine holes. In other embodiments, the gathering location may include a parking area for carts, a gathering area such as a courtyard, gazebo, sitting area, etc. for guests/members, and/or an area of the golf course, clubhouse, or the like acting as a meeting location for the event (e.g., a pro shop, a restaurant at the clubhouse, a practice green, a driving range, a geofenced area of GPS data, etc.).

The shelter location may include one or more locations at which individuals may seek shelter in the event of an emergency scenario (e.g., an area to take shelter for inclement weather, an open area away from structures to gather in the event of an earthquake/fire/etc., or the like). Like the above locations, the shelter locations may be stored as one or more geofences, GPS data, or the like. As an example, the shelter location(s) may include a rest stop, a restroom on the course, the clubhouse, an area beneath a bridge, an open area such as a field, parking lot, fairway, etc.

In some embodiments, the navigation data 412 may include a past and/or current location of one or more particular vehicles 10 of the plurality of vehicles 10. As an illustration, the current location may be provided by an operator interface, a sensor 490 detecting the location of the cart, a GPS device, or the like. In this way, the past and/or current location of the vehicle 10 may be stored and/or tracked in real time (e.g., a current vehicle location is received and updated every minute, every several seconds, etc.). The current vehicle location may be compared to or otherwise associated with the navigation data 412 such that the navigation system 400 may generate one or more routes to a target location (e.g., a starting hole for an event, a designated return location, or the like). The navigation system 400 may then determine and/or select the shortest route of the routes or a single shortest route from the current location of the vehicle (e.g., a starting location, the event gathering location, the clubhouse location, etc.) to the target location (e.g., a starting hole/tee box, a shelter location, etc.) and generate step-by-step instructions to the target location to be provided to the operator of the vehicle 10. As explained below, the step-by-step instructions may be generated, received, or otherwise provided to an operator interface (e.g., a display) of a particular vehicle 10 via a mapping system 414 of the navigation system 400.

The mapping system 414 may comprise one or more systems, circuits, programs, heuristics, algorithms, or the like configured to generate or otherwise provide turn-by-turn directions from a first location to a second location for one or more of the plurality of vehicles 10. For example, the mapping system 414 may receive predetermined route data included in the navigation data 412 of the memory 408. Predetermined route data may include a length of a certain path, a time of travel associated with a certain road for a vehicle going a certain speed, GPS data and/or geofence data identifying known routes and/or locations, or the like. As an illustration, the mapping system 414 may access one or more pathways of a golf course that lead to a specific tee box (e.g., pathway 1 to pathway 4 leads to tee box 2 from the clubhouse and comprises 2 miles of distance traveled). In some embodiments, the mapping system 414 may generate or otherwise receive turn-by-turn directions from a first location to a second location based on one or more of geographic information system (“GIS”) data, real-time data (e.g., the current location of one or more vehicles 10), topographical data, pathing/route algorithms, or the like. The mapping system 414 may receive the current location, the starting location, or another suitable location associated with a particular vehicle 10. The respective location may be expressed and/or communicated via GPS coordinates, a manually entered address, or another suitable method of location. The mapping system 414 may access the navigation data 412 which may include a database of maps, detailed information about roads, pathways, and various points of interest, travel data associated with previous vehicles 10 on the golf course, etc.

The mapping system 414, based on the designated first location and second location, may then determine the most efficient and/or shortest route between the first location (e.g., a starting point, a current location, etc.) and the second location (e.g., a starting tee box, a gathering location, a shelter location, etc.). The mapping system 414 may consider, select, or otherwise receive a route configured to minimize distance, minimize estimated travel time, maximize favorable traffic conditions, avoid road/path closures/congestion (e.g., as indicated by the location of other vehicles 10), and any other suitable preferences (e.g., avoiding private property, avoiding construction/closed pathways, avoiding areas affected by current weather conditions, or the like). The mapping system 414 may receive a pre-determined route (e.g., a route that is generally the shortest route between the clubhouse and the tee box of hole 1) and update/alter the route to determine a shorter route based on real-time data from various sources, such as the current location of other vehicles 10, data received from sensors 490, and the like.

The mapping system 414 may convert, generate, or otherwise communicate the route associated with a particular vehicle 10 via segments of data such as turn-by-turn directions as described above. The mapping system 414 may provide instructions including precise turns, landmarks, street names, and distances for each segment of the route from the first location to the second location. As the vehicle 10 progresses along the route, the mapping system 414 may continuously (e.g., constantly, every second, every minute, etc.) update the directions. In this way, the mapping system 414 may alter, provide a change in the route, or otherwise ensure that the vehicle 10 is instructed to take a route that minimizes distance, minimizes travel time, or the like based on any changes in path conditions, shifts in weather, etc.

The alert system 416 may comprise one or more systems, circuits, programs, heuristics, algorithms, or the like configured to receive an alert (e.g., an indication to shelter) and communicate the alert and/or the indication to shelter to the mapping system 414. The indication to shelter may be utilized by the mapping system 414 to generate a shortest route for one or more vehicles 10 from the current location of each particular vehicle 10 to a nearest shelter location. In this way, the navigation system 400 may, at any time before, during, and/or after the event has begun, provide the players with a route to a location to take shelter from inclement weather, emergency situations, or the like. For example, the indication to shelter may include at least one of a signal indicating inclement weather, a signal indicating a natural disaster, or a signal indicating an emergency event. The alert system 416 may receive the signal from the site monitoring and control system 200, via the network 210, from a data source 420 (e.g., a weather station, a radar, a radio broadcast, etc.), one or more of the sensors 490 (e.g., a humidity sensor, wind speed sensor, temperature sensor, etc.), etc.

The alert system 416 and/or the mapping system 414 may determine the type of shelter location based on the particular indication to shelter received. For example, weather events such as rain, hail, tornados/extreme wind, lightning, and the like may correspond to shelter locations at which players can take cover from the elements (e.g., the clubhouse, a rest area, a location with overhead protection/an interior space to seek shelter). Similarly, events such as earthquakes and fires may correspond to shelter locations providing open space away from the hazard (e.g., a parking lot, a field, a portion of a fairway, etc.). Additional shelter locations may correspond to other events as appropriate (e.g., an indication of an attacker on site may correspond to a shelter location a maximum distance away from the attacker and/or off site of the golf course, a location of a security office, etc.). In some embodiments, each shelter location may be designated one or more events/conditions that result in the particular shelter location being selected as a target destination for a particular vehicle 10. For example, the alert system 416 may utilize a look-up table, algorithm, or other heuristic to select only a subset of shelter locations to send to the mapping system 414 based on the type of indication to shelter received (e.g., heavy rain, flooding, blizzards indicate that shelter location A, B, C, etc. are acceptable but shelter locations X, Y, and Z are not acceptable). Similarly, the mapping system 414 and/or the alert system 416 may select a particular shelter location by prioritizing a shelter location closest to a particular vehicle 10, by considering the number of individuals already present (e.g., a capacity of) the shelter location, an open/closed status of the shelter location, etc.

In some embodiments, in response to receiving an “all clear” signal and/or in response to no longer receiving the indication to shelter, the navigation system 400 may determine and provide an updated shortest route (e.g., no longer leading the players to one or more shelter locations). The updated shortest route may return each particular vehicle 10 to their previous location on the golf course before/at the time the indication to shelter was received (e.g., a “resume play” route). In other embodiments, the updated shortest route may direct the players to a gathering location, the clubhouse, or the like (e.g., a “check in/receive further instructions” route). In this way, the navigation system 400 may permit efficient gathering of players for confirmation that the players sheltered successfully, for providing players updates regarding the event (e.g., the event will resume, will be delayed for an hour to let rain/hail pass, etc.).

The navigation system 400 may also receive and/or otherwise utilize data from one or more sensors 490 (e.g., 490a-n). The sensors 490 may be external to and/or site-specific sensors such as proximity detectors at a location on the golf course, Bluetooth receivers, geofences indicating a player/cart has entered/exited the geofence, weather radars, wind speed detectors, light level detectors, or the like. For example, in some embodiments, the alert system 416 may generate the indication to shelter based on a determination that rain/hail/snow is likely considering the information received from the sensors 490 (e.g., a low temperature, a high wind speed, a low light level, a high moisture reading at various sensors, etc.). Further, to save processing power, the navigation system 400 may update the current location of a vehicle 10 and/or may confirm that a vehicle 10 has arrived at a target location, designated return location, etc. based on that vehicle 10, a sensor 490 associated with a player (e.g., a smart watch, etc.) entering/exiting a geofence. As an illustration, the navigation system 400 may confirm that a player of the first cart group (e.g., cart one 501a) has arrived at their designated starting hole based on a signal indicating that cart one 501a entered a geofence adjacent to the tee box of the designated starting hole.

The controller 402 may provide the navigation instructions (e.g., turn-by-turn directions) generated by the mapping system 414 to the one or more vehicles 10 of the plurality of vehicles 10 at the golf course. In some embodiments, the controller 402 may be configured to receive the group data 410 associated with the plurality of vehicles 10. As an illustration, the controller 402 may receive player identifiers (e.g., player names) and cart identifiers (e.g., cart numbers, serial numbers, etc.) indicating which cart the player will be using for the event. In this way, the controller 402 may associate (e.g., assign) each one of the plurality of player identifiers with a respective one of the plurality of cart identifiers. The controller 402 may also receive navigation data 412 associated with at least one of the golf course or a respective vehicle 10 of the plurality of vehicles 10 to generate, via the mapping system 414, a shortest route to a target location for that particular vehicle 10. For example, at the start of the event, the controller 402 may determine the shortest route, for each vehicle 10, to that vehicle's starting tee location and display, via the operator interface of each particular vehicle 10, the shortest route to the starting tee location assigned to that particular vehicle 10.

The controller 402 may also receive, for each particular vehicle 10 (e.g., at an event end time), the current location of the particular vehicle 10 and determine, based on the group data and the navigation data, a shortest route for each particular vehicle to the designated return location associated with the particular vehicle. As an illustration, for an event with a shotgun start scheduled to end at 5:00 pm and/or in response to a particular vehicle 10 completing its final hole on the course, the controller 402 may generate a shortest route for that vehicle 10 to the clubhouse and provide, via the operator interface of the particular vehicle, the shortest route to player(s).

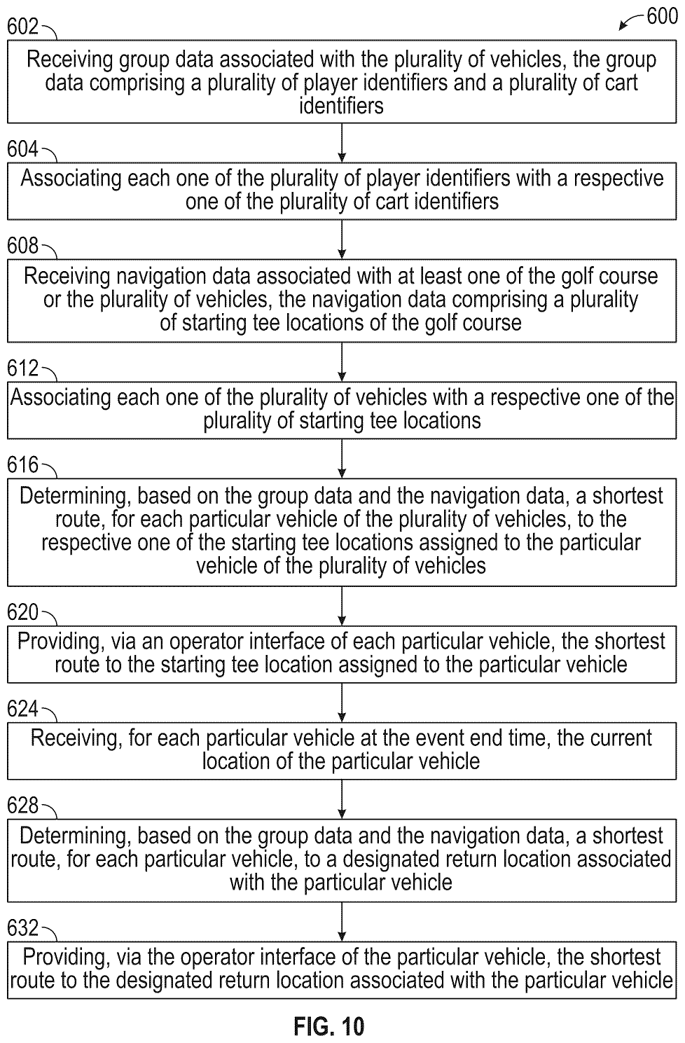

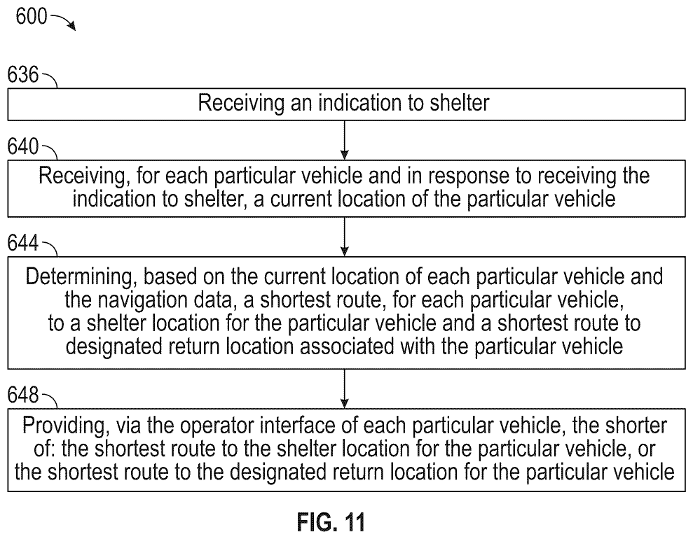

Turning to FIGS. 10 and 11, example steps for a method 600 for providing navigation instructions to a plurality of vehicles at a golf course is shown according to an exemplary embodiment. Non-limiting illustrations of the method 600 are provided in FIGS. 4-9, which illustrate an example golf course, players/vehicles 10, and GUI interfaces 900 of the navigation system 400 including example embodiments illustrating the receipt and display of turn-by-turn directions for a particular vehicle 10, the determining of the shortest route from a first location to a second location for the particular vehicle 10, etc.

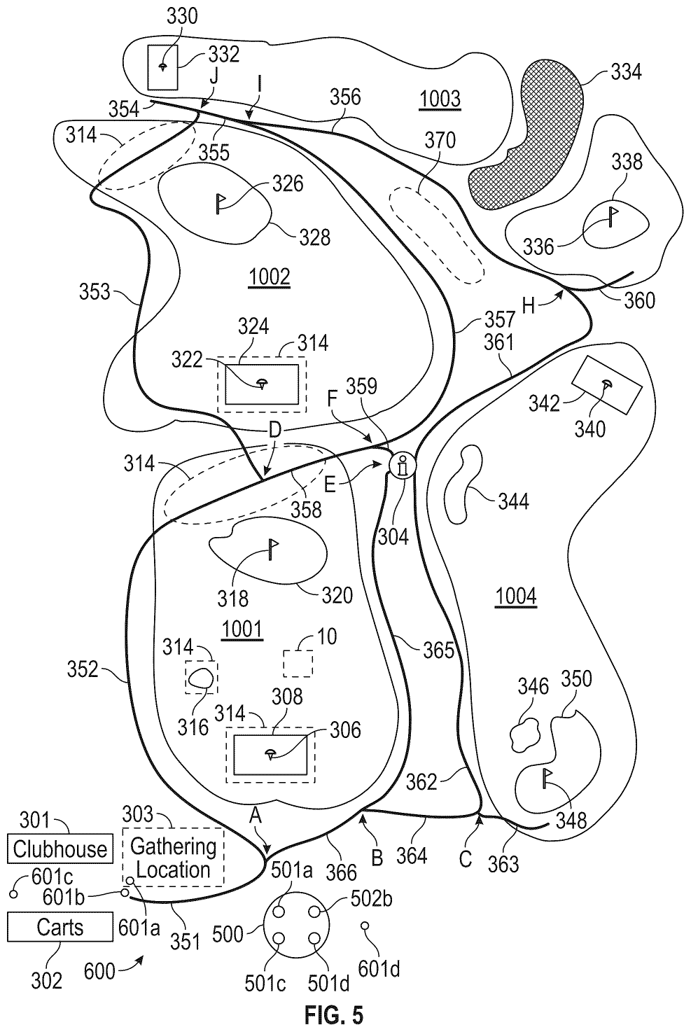

As shown in FIGS. 5, 6, and 8, the golf course includes a plurality of holes, shown as first hole 1001, second hole 1002, third hole 1003, fourth hole 1004, etc. The first hole 1001 of the golf course includes a tee, shown as first tee 306, a tee box, shown as first tee box 308, a plurality of geofences, shown as geofences 314, one or more hazards (e.g., a water hazard, woods, fescue, non-playable area, area under repair, etc.), shown as hazard 316, a pin, shown as first pin 318, the vehicle 10, and a green, shown as first green 320. The geofences 314 include a tee box geofence surrounding the first tee box 308, a green geofence proximate the first green 320, and/or a hazard geofence (e.g., a geofence 314 surrounding the hazard 316, etc.). The second hole 1002 of the golf course includes a tee, shown as second tee 322, a tee box, shown as second tee box 324, one or more geofences 314, a pin, shown as second pin 326, and a green, shown as a second green 328. The third hole 1003 of the golf course includes a third tee 330, a third tee box 332, a water hazard 334, one or more geofences (not shown) a third pin 336, and a third green 338. Likewise, the fourth hole 1004 of the golf course includes a fourth tee 340, a fourth tec box 342, one or more hazards (e.g., hazards 344, 346), one or more geofences (not shown), a fourth pin 348, and a fourth green 350. The golf course may include more than four holes (e.g., a nine-hole course, an eighteen-hole course, etc.), more than four tees, more than four pins, more than four putting greens, any number of hazards, more than four tee boxes, etc.

The golf course may also include a clubhouse 301, a cart storage location 302, a gathering location 303, and one or more other structures such as rest stop 304 (e.g., “rest stop (i)”). As discussed above, the gathering location 303 may be a pre-determined area defined by a geofence, GIS data, GPS coordinates or the like. In some embodiments, the gathering location 303 may be generated for a particular event at the golf course. The golf course includes a series of pathways and intersections for carts/players to navigate from hole to hole. For example, the pathways may be identified based on particular segments separated by intersections. As illustrated in FIGS. 5, 6, and 8, the golf course may include pathways 351, 352, 353, 354, 355, 356, 357, 358, 359, 360, 361, 362, 363, 364, 365, etc. The golf course may also include intersections (e.g., points/locations at which two or more segments of the pathways connect, points where a vehicle is presented with a choice of which pathway to follow, etc.). For example, as illustrated, the golf course includes intersections A, B, C, D, E (e.g., a roundabout surrounding rest stop 304), F, H, I, and J, etc. As an example, pathway 351 leads from the clubhouse 301, cart storage location 302, and/or gathering location 303 to intersection A at the head of the first hole 1001. Taking a left at intersection A leads to pathway 352 extending along the length of the first hole 1001. Taking a right at intersection A leads to pathway 366 heading in the direction of the fourth hole 1004. The golf course may also include municipal roads, private roads, unmarked pathways (e.g., distances/common paths taken across fields, fairways, parking lots, and the like). The navigation system 400 may associate any or all of the pathways, roads, intersections, etc. with a corresponding distance, speed limit, average travel time to cross, current congestion condition, open/closed status, or any other suitable attribute for consideration when determining the shortest route from a first location to a second location.

The method 600 may include step 602 of receiving group data 410 associated with the plurality of vehicles 10 (e.g., a plurality of player identifiers and a plurality of cart identifiers as discussed above). As shown in FIG. 5, the navigation system 400 may designate/identify the carts into one or more groups such as first cart group 500 including first cart 501a, second cart 501b, third cart 501c, and fourth cart 501d. Similarly, even if carts within a cart group are spread out and/or are located at disparate areas across the course, the navigation system 400 may track, recognize, or otherwise associate the carts as a group as with the second cart group 670 comprising first cart 601a, second cart 601b, third cart 601c, and fourth cart 601d.

The method 600 may include step 604 of assigning or associating each one of the plurality of player identifiers a respective one of the plurality of cart identifiers. For example, a list of players attending the event may include a player name, a player ID number, a player member number or the like. Each respective player may be associated or assigned a cart to use for the event by linking the player identifier to the cart identifier. As an illustration, players Johnson, Smith, Murphy, and Carter may be assigned to the first cart group 500 with Johnson associated with cart 501a, Smith associated with cart 501b, Murphy associated with cart 501c, and Carter associated with cart 501d. In other embodiments, multiple players may be assigned to the same cart (e.g., cart group one 500 could include eight players with players Carter and Murphy both assigned to cart 501c).

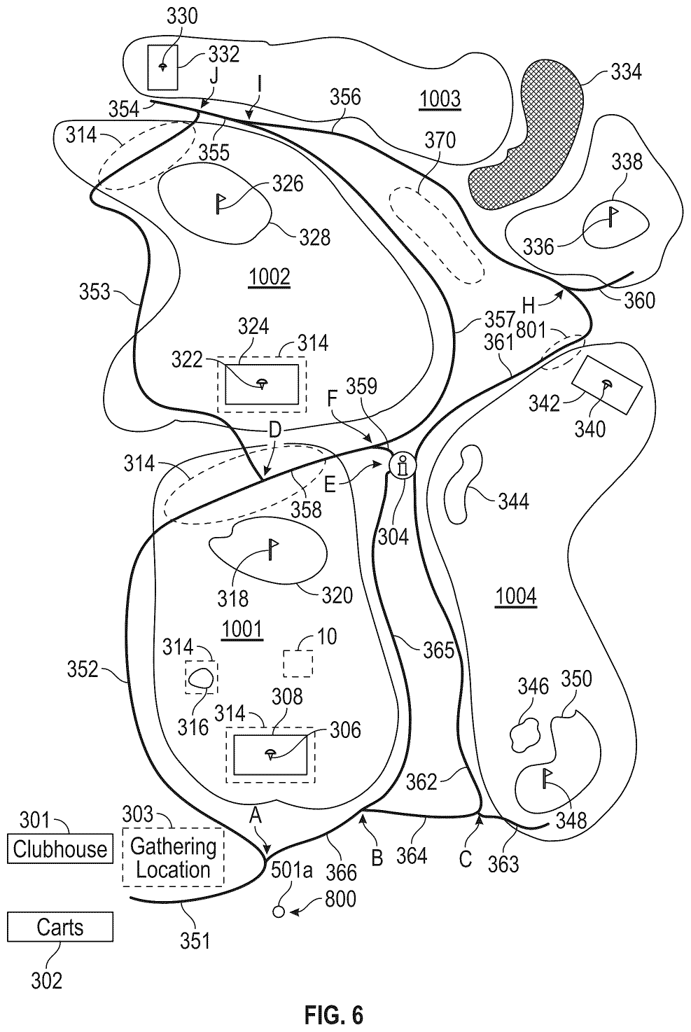

The method 600 may include step 608 of receiving navigation data associated with at least one of the golf course or the plurality of vehicles 10. For example, the navigation system 400 may receive a current cart location of any and/or all of the carts (e.g., the locations of carts of the first cart group 500 and the second cart group 670 shown in FIG. 5, the location of a single cart such as first cart 501a shown in FIG. 6, etc.). The navigation data may also include any or all of the navigation data described above such as one or more starting tee locations of the golf course, data associated with the pathways, intersection, roads, structures, congestion data, etc.

The method 600 may include step 612 of assigning or associating each one of the plurality of vehicles 10 a respective one of the plurality of starting tee locations. For example, for an event with a shotgun start, each group of carts simultaneously proceeds to their respective starting tees. As an illustration, the first cart group 500 may be assigned to start at the fourth tee box 342 of the fourth hole 1004, the second cart group 670 may be assigned to start at the third tee box 332 of the third hole 1003, etc.

The method 600 may include step 616 of determining, based on the group data and the navigation data, a shortest route, for each particular vehicle 10 of the plurality of vehicles 10, to the respective one of the starting tee locations assigned to the particular vehicle 10 of the plurality of vehicles 10. This step 616 is best illustrated in FIG. 6. In FIG. 6, the navigation system 400 receives or otherwise identifies a first location 800 of the first cart 501a of the first cart group 500 (e.g., a starting location such as the current location of first cart 501a). The navigation system 400 also receives or otherwise identifies a second location 801 designated as the target destination for the respective cart (e.g., a geofence associated with the starting tee location for the fourth tee box 342, which was assigned to the carts of the first cart group 500). The navigation system 400 may then determine the shortest route (e.g., based on a calculation considering the segment distances, congestion of the pathways, locations of other carts, etc.). For example, an example shortest route is illustrated as including intersection A, pathway 366, intersection B, pathway 365, roundabout E, and pathway 361 (circled in FIG. 6). Further, the navigation system 400 may generate, receive, and/or otherwise provide the shortest route as a set of turn-by-turn directions. An example set of turn-by-turn directions may include “turn right at intersection A in 50 feet, follow pathway 366 to intersection B, keep left at intersection B and follow pathway 365, at the roundabout E, take the second exit to pathway 361 and travel 120 feet to the fourth tee box 342.” Other suitable instructions, as would be known by a person of ordinary skill in the art, are contemplated. Additionally, the navigation system 400 may generate, update, and provide, simultaneously or substantially simultaneously, a respective shortest route for each vehicle 10 (e.g., different routes for each cart 501a-d, 601a-d based on the respective cart's location).

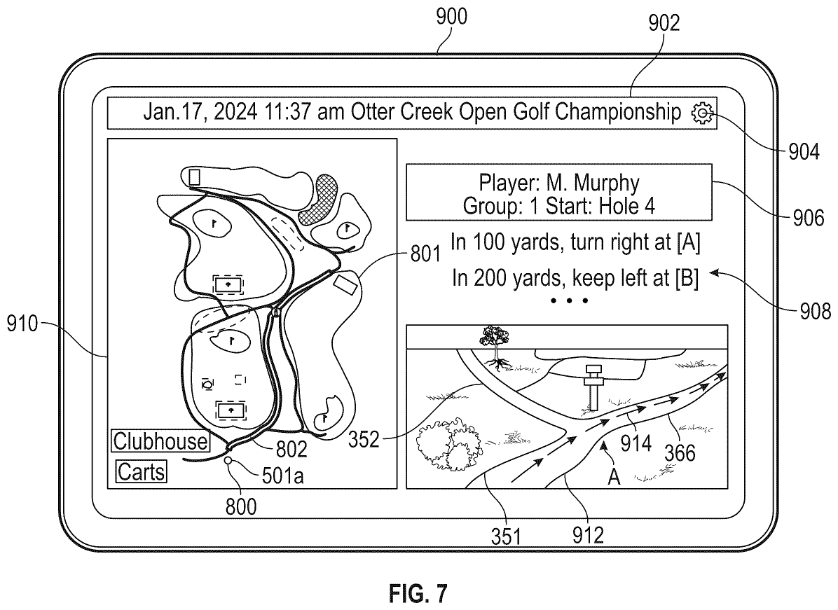

The method 600 may include step 620 of providing, via an operator interface of each particular vehicle 10, the shortest route to the starting tee location assigned to the particular vehicle 10. For example, turning to FIG. 7, an example operator interface such as a display having a GUI is shown illustrating the shortest route to the starting tee location for the first cart 501a of the first cart group 500. The GUI 900 may include informative data 902 such as a date, time, event name/identifier, or the like. Additionally, the GUI may include one or more interactable items such as a settings button 904. The settings button 904 may allow the player to toggle audio levels of the turn-by-turn instructions, add/remove presentation modes of the turn-by-turn instructions, or otherwise customize the GUI 900. The GUI 900 may also include cart specific information 906 such as the player identifier(s) associated with the cart, the group number/identified associated with the cart, the designated starting hole, the next target hole, etc. Also as shown in FIG. 7, the turn-by-turn directions may be received or otherwise provided as sequential steps that update based on a current location of the vehicle 10. For example, the operator of the first cart 501a is instructed to turn right at intersection A in 100 yards. The upcoming step is shown below the first step. After turning right at intersection A, the GUI 900 may update such that the first step is replaced by the second step, and a third step is shown as a new upcoming step. The GUI 900 and/or the navigation system 400 may also generate a map 910 with an overlay 802 highlighting the shortest route and the progress of the vehicle 10, may provide a view from a front facing camera of the cart and/or a virtual environment representing the golf course with an overlay 914, or any other suitable prompt to accompany/represent the turn-by-turn direction.

The method 600 may also navigate one or more vehicles back to a designated return location (e.g., the clubhouse 301, the vehicle's original starting location, etc.). For example, at the conclusion of the event or at another suitable time (e.g., at a break, at a mealtime, completion of the round of golf, etc.), the method 600 may include step 624 of receiving, for each particular vehicle 10 at the event end time, the current location of the particular vehicle 10. For example, the current location of cart 501a may include the location 801 (e.g., cart 501a just arrived at the third hole 1003) and the designated return location may include the original starting location 800 of cart 501a.

The method 600 may include step 628 of determining, based on the group data and the navigation data, a shortest route, for each particular vehicle 10, to the designated return location associated with the particular vehicle 10. In a same and/or similar manner to generating the shortest route to the starting tee location, the navigation system 400 may generate, determine, and/or otherwise provide a shortest route to the return location in any of the manners described above.

The method 600 may include step 632 of providing, via the operator interface of the particular vehicle 10, the shortest route to the designated return location associated with the particular vehicle 10. For example, as shown in FIG. 7, the current location may include location 801, the designated return location may include location 800, and the shortest route may be the opposite of the route described above (e.g., the route designated on map 910 via overlay 802).

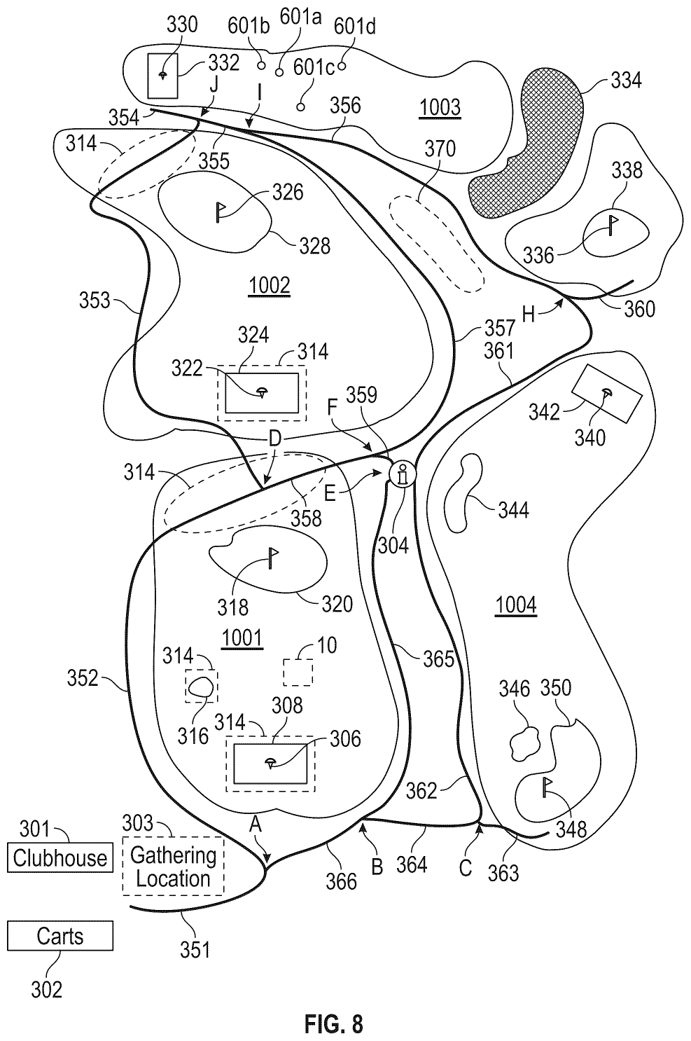

Focusing now on FIGS. 8, 9, and 11, the method 600 may include step 636 of receiving an indication to shelter. As illustrated in FIG. 8, the second cart group 670 may be in the middle of play (e.g., on the fairway of the third hole 1003). The navigation system 400 may receive an indication to shelter such as a weather report indicating approaching rain, a tornado warning, an indication of an activation of a fire alarm, etc. Based on the indication to shelter, the navigation system 400 may select an appropriate shelter location (e.g., a closest location suitable to shelter from the particular hazard) and determine, generate, or otherwise provide a shortest route to the shelter location as described herein.

The method 600 may include step 640 of receiving, for each particular vehicle 10 and in response to receiving the indication to shelter, a current location of the particular vehicle 10. As an example, the navigation system 400 may receive the locations associated with each vehicle 10 of the second cart group 670 (e.g., carts 601a-d) as illustrated in FIG. 8.

The method 600 may include step 644 of determining, based on the current location of each particular vehicle 10 and the navigation data, a shortest route, for each particular vehicle 10, to a shelter location for the particular vehicle 10 and a shortest route to designated return location associated with the particular vehicle 10. In this way, if the vehicles 10 are closer to a location such as the clubhouse 301, returning the vehicles 10 and the players to the clubhouse 301 may take priority over sending the vehicles 10 to a remote shelter location. Similarly, if the vehicles 10 are further away from the clubhouse 301 (or another designated return location), the navigation system 400 may choose to send the vehicles 10 to a shelter location more proximate to their position (e.g., allowing the players to take shelter faster than returning all the way to the designated return location). For example, as shown in FIG. 8, the navigation system 400 may receive a hail warning and select an appropriate shelter location (e.g., cover provided by rest stop 304). The navigation system 400 may determine, for each cart 601a-d, a respective shortest route to the shelter location. As illustrated in FIG. 8, the shortest route to the shelter location may include taking intersection I to pathway 357, turning left at intersection F onto pathway 355, and stopping at roundabout E to reach the shelter location of rest stop 304. The navigation system 400 may also determine the shortest route to the designated return location (e.g., the clubhouse 301). For example, the shortest route to the clubhouse 301 would require that the vehicles 10 in FIG. 8 continue past the rest stop 304 and travel along pathway 365, to pathway 366, to pathway 351.

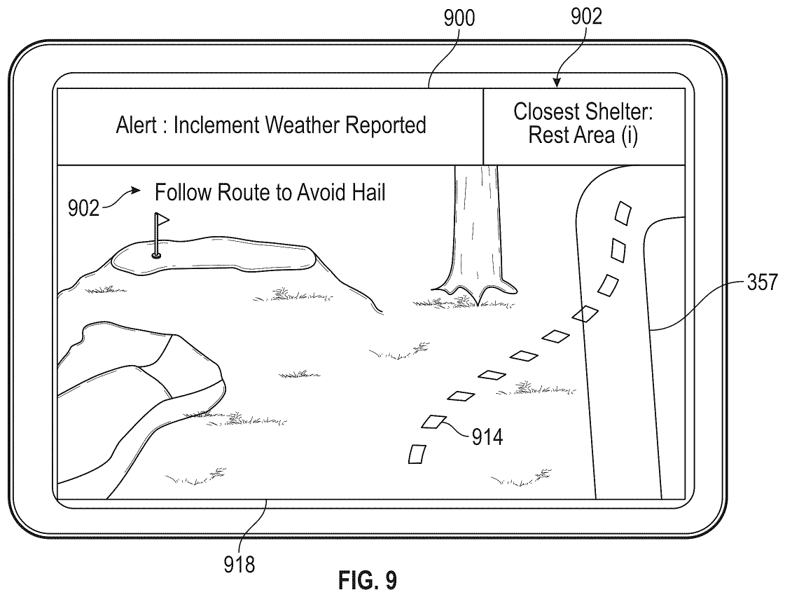

The method 600 may include step 648 of providing, via the operator interface of each particular vehicle 10, the shorter of the shortest route to the shelter location for the particular vehicle 10, or the shortest route to the designated return location for the particular vehicle 10. For example, as shown in FIG. 9, a GUI 900 of an example vehicle 10 from the second cart group 670 is shown according to an example embodiment. Because the route to the shelter location (rest stop 304) is shorter than the route to the designated return location (clubhouse 301), the GUI 900 provides instructions directing the vehicle 10 to the rest stop such that the players may more quicky shelter from the weather condition (e.g., hail). In other embodiments and/or for other indications to shelter (e.g., a fire alarm/fire alert), the shelter location chosen may instead be open area 370 to gather players away from flammable structures, smoke, or other hazards. As shown in FIG. 9, the turn-by-turn directions may be presented on the GUI 900 as a front camera view 918 including a generating an overlay 914 (e.g., virtual pathing markers) for the vehicle 10 to follow. The GUI 900 may also include informative data 902 (e.g., an indication of the specific alert/hazard, an indication of the destination to shelter, etc.). Further, the GUI 900 may receive informative data 902 such as an instruction to display from the navigation system 400 (e.g., Follow route to avoid hail). The instruction may be predesignated based on the indication to shelter or may be manually received (e.g., from an operator interface of the navigation system 400 such that organizers of the event can provide live updates regarding the condition to each player).

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.), the site monitoring and control system 200 (e.g., the remote systems 240, the user portal 230, the user sensors 220, etc.), and the navigation system 400 as shown in the various exemplary embodiments is illustrative only. Additionally, any element disclosed in one embodiment may be incorporated or utilized with any other embodiment disclosed herein.

1. A navigation system for a golf course, the navigation system comprising:
a plurality of vehicles, each having an operator interface;
one or more processing circuits including one or more memory devices storing instructions thereon that, when executed by one or more processors, cause the one or more processors to:
acquire group data associated with the plurality of vehicles, the group data comprising a plurality of player identifiers and a plurality of cart identifiers;
associate each one of the plurality of player identifiers with a respective one of the plurality of cart identifiers;
acquire navigation data associated with at least one of the golf course or the plurality of vehicles, the navigation data comprising a plurality of starting tee locations of the golf course;
associate each one of the plurality of vehicles with a respective one of the plurality of starting tee locations;
determine, based on the group data and the navigation data, a shortest route, for each particular vehicle of the plurality of vehicles, to the respective one of the starting tee locations assigned to the particular vehicle of the plurality of vehicles; and
simultaneously provide, via the operator interface of each particular vehicle, the shortest route to the starting tee location assigned to each particular vehicle of the plurality of vehicles.

2. The navigation system of claim 1, wherein the group data further comprises at least one of a group of players, a number of players in the group of players, or event information associated with an event at the golf course.

3. The navigation system of claim 2, wherein the event information includes at least an event start time and an event end time.

4. The navigation system of claim 1, wherein the navigation data comprises at least one of a course layout, a pin location, a current location of the particular vehicle for each particular vehicle, a shelter location, a clubhouse location, a cart storage location, or an event gathering location.

5. The navigation system of claim 4, wherein the instructions, when executed by the one or more processors, cause the one or more processors to:
acquire, for each particular vehicle at an event or round end, the current location of the particular vehicle;
determine, based on the group data and the navigation data, a shortest route, for each particular vehicle, to a designated return location associated with the particular vehicle; and
provide, via the operator interface of the particular vehicle, the shortest route to the designated return location associated with the particular vehicle;
wherein the designated return location includes at least one of the clubhouse location, the cart storage location, or the event gathering location.

6. The navigation system of claim 5, wherein the instructions, when executed by the one or more processors, cause the one or more processors to:
provide, via a GUI of the operator interface of the particular vehicle, the shortest route to the starting tee location and the shortest route to the designated return location as a set of turn-by-turn directions; and
wherein the set of turn-by-turn directions associated with the particular vehicle is configured to be sequentially displayed based on the current location of the particular vehicle.

7. The navigation system of claim 1, wherein the instructions, when executed by the one or more processors, cause the one or more processors to:
acquire an indication to shelter;
acquire, for each particular vehicle and in response to receiving the indication to shelter, a current location of the particular vehicle;
determine, based on the current location of each particular vehicle and the navigation data, a shortest route, for each particular vehicle, to a shelter location for the particular vehicle and a shortest route to a designated return location associated with the particular vehicle; and
provide, via the operator interface of each particular vehicle, the shorter of:
the shortest route to the shelter location for the particular vehicle; or
the shortest route to the designated return location for the particular vehicle; and
wherein the indication to shelter includes at least one of a signal indicating inclement weather, a signal indicating a natural disaster, or a signal indicating an emergency event.

8. A navigation system for a golf course for providing navigation instructions to a plurality of vehicles at a golf course, the navigation system comprising:
a non-transitory computer-readable medium having instructions stored thereon that, when executed by one or more processors, cause the one or more processors to:
acquire group data associated with a plurality of vehicles, the group data comprising a plurality of player identifiers and a plurality of cart identifiers;
associate each one of the plurality of player identifiers with a respective one of the plurality of cart identifiers;
acquire navigation data associated with the golf course, the navigation data comprising a plurality of starting tee locations of the golf course;
associate each one of the plurality of vehicles with a respective one of the plurality of starting tee locations;
determine, based on the group data and the navigation data, a shortest route, for each particular vehicle of the plurality of vehicles, to the respective one of the starting tee locations assigned to the particular vehicle of the plurality of vehicles; and
provide, via the operator interface of each particular vehicle, the shortest route to the starting tee location assigned to each particular vehicle of the plurality of vehicles.

9. The navigation system of claim 8, wherein the group data further comprises at least one of a group of players, a number of players in the group of players, or event information associated with an event at the golf course.

10. The navigation system of claim 9, wherein the event information includes at least an event start time and an event end time.

11. The navigation system of claim 9, wherein the navigation data comprises at least one of a course layout, a pin location, a current location of the particular vehicle for each particular vehicle, a shelter location, a clubhouse location, a cart storage location, or an event gathering location.

12. The navigation system of claim 11, wherein the instructions, when executed by the one or more processors, cause the one or more processors to:
acquire, for each particular vehicle at an event or round end, the current location of the particular vehicle;
determine, based on the group data and the navigation data, a shortest route, for each particular vehicle, to a designated return location associated with the particular vehicle; and
provide, via the operator interface of the particular vehicle, the shortest route to the designated return location associated with the particular vehicle;
wherein the designated return location includes at least one of the clubhouse location, the cart storage location, or the event gathering location.

13. The navigation system of claim 12, wherein the instructions, when executed by the one or more processors, cause the one or more processors to:
provide, via a GUI of the operator interface of the particular vehicle, the shortest route to the starting tee location and the shortest route to the designated return location as a set of turn-by-turn directions; and
wherein the set of turn-by-turn directions associated with the particular vehicle is configured to be sequentially displayed based on the current location of the particular vehicle.

14. The navigation system of claim 1, wherein the instructions, when executed by the one or more processors, cause the one or more processors to:
acquire an indication to shelter;
acquire, for each particular vehicle and in response to receiving the indication to shelter, a current location of the particular vehicle;
determine, based on the current location of each particular vehicle and the navigation data, a shortest route, for each particular vehicle, to a shelter location for the particular vehicle; and
provide, via the operator interface of each particular vehicle, the shortest route to the shelter location for the particular vehicle.

15. A method for providing navigation instructions to a plurality of vehicles at a golf course, the method comprising:
acquiring group data associated with the plurality of vehicles, the group data comprising a plurality of player identifiers and a plurality of cart identifiers;
associating each one of the plurality of player identifiers with a respective one of the plurality of cart identifiers;
acquiring navigation data associated with at least one of the golf course or the plurality of vehicles, the navigation data comprising a plurality of starting tee locations of the golf course;
associating each one of the plurality of vehicles with a respective one of the plurality of starting tee locations;
determining, based on the group data and the navigation data, a shortest route, for each particular vehicle of the plurality of vehicles, to the respective one of the starting tee locations assigned to the particular vehicle of the plurality of vehicles; and
simultaneously providing, via an operator interface of each particular vehicle, the shortest route to the starting tee location assigned to the particular vehicle.

16. The method of claim 15, wherein:
the group data comprises at least one of a group of players, a number of players in the group of players, or an event start time and an event end time associated with an event at the golf course; and
the navigation data comprises at least one of a course layout, a pin location, a current location of the particular vehicle, a shelter location, a clubhouse location, a cart storage location, or an event gathering location.

17. The method of claim 15, further comprising:
acquiring, for each particular vehicle at an event or round end, the current location of the particular vehicle;
determining, based on the group data and the navigation data, a shortest route, for each particular vehicle, to a designated return location associated with the particular vehicle;
providing, via the operator interface of the particular vehicle, the shortest route to the designated return location associated with the particular vehicle.

18. The method of claim 17, wherein:
the shortest route to the starting tee location and the shortest route to the designated return location includes a set of turn-by-turn directions are provided via a GUI of the operator interface of the particular vehicle; and
wherein the set of turn-by-turn directions associated with the particular vehicle is configured to be sequentially displayed based on the current location of the particular vehicle.

19. The method of claim 15, further comprising:
acquiring an indication to shelter;
acquiring, for each particular vehicle and in response to receiving the indication to shelter, a current location of the particular vehicle;
determining, based on the current location of each particular vehicle and the navigation data, a shortest route, for each particular vehicle, to a shelter location for the particular vehicle; and
providing, via the operator interface of each particular vehicle, the shortest route to the shelter location for the particular vehicle.

20. The method of claim 19, wherein the indication to shelter includes at least one of a signal indicating inclement weather, a signal indicating a natural disaster, or a signal indicating an emergency event.
